(19) United States
(12) Patent Application Publication
(10) Pub. No.: US 2017/0176304 A1
(43) Pub. Date: Jun. 22, 2017

(54) ELECTROPHORETIC TISSUE CLEARING CHAMBER AND USES THEREOF

(71) Applicant: Justin WAJCER-LESSARD, Mont-Royal (CA)

(72) Inventor: Justin WAJCER-LESSARD, Mont-Royal (CA)

(21) Appl. No.: 15/381,478

(22) Filed: Dec. 16, 2016

Related U.S. Application Data
(60) Provisional application No. 62/268,189, filed on Dec. 16, 2015.

(51) Int. Cl. G01N 1/40; G01N 27/453; G01N 1/30

(52) U.S. Cl. CPC G01N 1/40; G01N 1/30; G01N 27/453; G01N 2001/4038; G01N 1/31

(57) ABSTRACT

The present document describes an electrophoretic tissue clearing chamber comprising an electrophoresis channel, configured to receive a clarification fluid therethrough; a first clarification fluid inlet, in fluid communication with the electrophoresis channel, configured to be connected to a source of the clarification fluid; a tissue sample holder in fluid communication with the electrophoresis channel, configured to receive a tissue sample to be clarified, and pressurize and homogenously apply the clarification fluid onto the tissue sample; a clarification fluid outlet, in fluid communication with the tissue sample holder, for exit of the clarification fluid from the electrophoretic tissue clearing chamber; and first and a second electrode, opposite one another in the electrophoresis channel, for transmission of an electric field therethrough.

### CROSS-REFERENCE TO RELATED APPLICATIONS

This application claims priority of U.S. provisional patent application 62/268,189 filed on Dec. 16, 2015, the specification of which is hereby incorporated by reference in its entirety.

### BACKGROUND

(A) Field

The subject matter disclosed generally relates to electrophoretic chambers, and more particularly to electrophoretic chambers for tissue clearing.

(b) Related Prior Art

Confocal microscopy methods have revolutionized light microscopy by initiating the optical sectioning of different thicknesses (tens of micrometers) through a tissue sample and have allowed the visualization of the fluorescence of samples after laser excitation, enabling 3D reconstruction without the need to make physical isolation. However, the applicability of light microscopy remains limited for imaging through intact nervous systems, as mouse brains cover many millimeters even in the shortest dimension, and they are opaque at this scale mainly because of the fat which prevents the dispersion of light. An integrative approach would be ideal to label and image vertebrate brains intact at high resolution.

New methods have increased the transparency by reducing light dispersion through the sample tissue fabric chemically. Although these approaches are feasible, they are not effective because that they cannot render oligonucleotides transparent. When soft tissues, such as the mammary glands, are probed by immunohistochemistry using hydrophobic solutions that reduce lipid barriers, fluorophores become very unstable or sanctioned in the clarification process (a step which must be followed during antibody staining, because transparency will nevertheless be lost).

Deisseroth and colleagues (Tomer R, et al. Nat. Protoc 2014, 9:1682-1697), from University Stanford, develop a new method—CLARITY—involving the removal of lipids in a stable hydrophilic chemical environment to ensure transparency of intact tissue, the preservation of the structure and the fluorescence and biomolecular accessibility to the original content to antibodies and nucleic acid probes.

The CLARITY technology, making tissue samples optically transparent and permeable to macromolecules, provided a major advanced in imaging of biological systems. This method improved the permeability of tissues by replacing the lipid bilayer of plasma membranes with a nanoporous hydrogel that freeze the structural amino acids of the brain, keeping only the free lipids.

Unlike mechanical methods of microdissection, which aggravate the deformation of tissue structure, CLARITY preserve the organ structure intact allowing the three-dimensional (3D) topological reconstruction of these organs.

CLARITY has two different methods to proceeds to the clarification of tissues and organs. The first involves passive diffusion of clarifying solution through the tissue or organ, which lasts approximately 28 days, and the second involves an electrophoresis based approach, which is much faster, but is riskier as it may damage the tissue sample or simply fail to clarify the sample. The second approach makes use of an electrophoretic tissue clarification chamber that appears to be less then optimal for the desired use.

Therefore, there is a need for an electrophoretic tissue clearing chambers that mitigates the disadvantages of the electrophoretic tissue clearing chambers of the prior art.

There is a need for an electrophoretic tissue clearing chambers that accelerates tissue clearing speed compared to the electrophoretic tissue clearing chambers of the prior art.

There is a need for an electrophoretic tissue clearing chambers that improves the quality of tissue clearing compared to the electrophoretic tissue clearing chambers of the prior art.

### SUMMARY

According to an embodiment, there is provided an electrophoretic tissue clearing chamber comprising:
an electrophoresis channel, configured to receive a clarification fluid therethrough;
a first clarification fluid inlet, in fluid communication with the electrophoresis channel, configured to be connected to a source of the clarification fluid;
a tissue sample holder in fluid communication with the electrophoresis channel, configured to receive a tissue sample to be clarified, and pressurize and homogenously apply the clarification fluid onto the tissue sample;
a clarification fluid outlet, in fluid communication with the tissue sample holder, for exit of the clarification fluid from the electrophoretic tissue clearing chamber; and
a first and a second electrode, opposite one another in the electrophoresis channel, for transmission of an electric field therethrough.

The electrophoresis tissue clearing chamber may further comprise a second clarification fluid inlet, in fluid communication with the electrophoresis channel, configured to be connected to a source of the clarification fluid, and provide an opposing flow of clarification fluid to a flow of clarification fluid from the first clarification fluid inlet, to generate turbulent flow against the tissue samples.

The electrophoresis tissue clearing chamber may further comprise first and second viewing windows, opposite one another in the electrophoresis channel, for visualization of the tissue samples therein.

The tissue sample holder may comprise a plurality of fluid entry aperture for homogeneous and pressurized application of the clarification fluid onto the tissue samples.

The tissue sample holder may comprise a plurality of fluid exit aperture for exit of the fluid from the tissue sample holder.

The tissue sample holder may comprise a porous surface, for exit of the clarification fluid from the tissue sample holder after contacting the tissue sample.

The electrophoresis tissue clearing chamber of claim 1, further comprising a second clarification fluid inlet, for providing an opposing flow of clarification fluid to a flow of clarification fluid from the first clarification fluid inlet.

The tissue holder may be integral to the electrophoresis channel.

The tissue holder may be separate and inserted into the electrophoresis channel.

The tissue holder may comprise a tissue holder first portion sealably joined to a tissue holder second portion.

The electrophoresis tissue clearing chamber may comprise
a first portion comprising
   the first clarification fluid inlet, in fluid communication with the electrophoresis channel, configured to be connected to a source of the clarification fluid;
   a tissue sample holder first portion, comprising means to pressurize and homogenously apply the clarification fluid onto the tissue sample; and
   the first electrode,
and
a second portion comprising
   a tissue sample holder second portion, configured to receive a tissue sample to be clarified, comprising means for exit of the clarification fluid;
   the clarification fluid outlet, in fluid communication with the tissue sample holder second portion, for exit of the clarification fluid from the electrophoretic tissue clearing chamber; and
   the second electrode,
      wherein the tissue sample holder first portion and the tissue sample holder second portion reversibly join to form the tissue sample holder, thereby sealably joining the first and second portion to form the electrophoresis tissue clearing chamber.

The electrophoresis tissue clearing chamber may comprise
a first portion comprising
   the first clarification fluid inlet, in fluid communication with the electrophoresis channel, configured to be connected to a source of the clarification fluid;
   the first electrode,
a second portion comprising
   the clarification fluid outlet, in fluid communication with the tissue sample holder second portion, for exit of the clarification fluid from the electrophoretic tissue clearing chamber; and
   the second electrode,
wherein the tissue sample holder comprises
   a tissue sample holder first portion, comprising means to pressurize and homogenously apply the clarification fluid onto the tissue sample; and
   a tissue sample holder second portion, configured to receive a tissue sample to be clarified, comprising means for exit of the clarification fluid;
wherein the tissue sample holder first portion and the tissue sample holder second portion are configured to reversibly join to form the tissue sample holder, and
wherein the tissue sample holder inserts into the second portion, and
   wherein the first and second portion sealably and reversibly join to form the electrophoresis tissue clearing chamber.

The means to pressurize and homogenously apply the clarification fluid onto the tissue sample may comprise a plurality of fluid entry apertures, for homogeneous and pressurized application of the clarification fluid onto the tissue sample.

The means for exit of the clarification fluid may comprise a plurality of fluid exit apertures, a porous surface, or a combination thereof, for exit of the clarification fluid from the tissue sample holder after contacting the tissue sample.

According to another embodiment, there is provided a method for clarifying a tissue sample comprising the step of:
a) treating the tissue sample in an electrophoretic tissue clearing chamber according to claim 1, having a clarification fluid and a suitable electric current flowing therethrough, for a time sufficient, at a flow rate sufficient to clarify the tissue.

The tissue sample may be a fixed tissue sample.

The following terms are defined below.

The term “tissue sample” is intended to mean an entire organ or pieces, slices, segments or fragments thereof, of animal or human origin, that may be treated with the tissue clarification chamber of the present invention. According to an embodiment, the tissue sample may be fixed. In the fields of histology, pathology, and cell biology, fixation is a critical step in the preparation of histological sections by which biological tissues are preserved from decay, thereby preventing autolysis or putrefaction. The structure of a tissue is determined by the shapes and sizes of macromolecules in and around cells. The principal macromolecules inside a cell are proteins and nucleic acids. Fixation terminates any ongoing biochemical reactions, and may also increase the mechanical strength or stability of the treated tissues. The broad objective of tissue fixation is to preserve cells and tissue components and to do this in such a way as to allow for the preparation of thin, stained sections. The fixation solution may be for example a hydrogel solution such as described in US Patent Application No. US2015/2015/0144490, which is incorporated herein by reference in its entirety. For example, the hydrogel solution may comprise acrylamide (40% wt/wt), nis-acrylamide (0.025% wt/wt), VA-044 initiator (i.e. 2,2′-Azobis[2-(2-imidazolin-2-yl)propane]dihydrochloride—0.25% wt/wt), paraformaldehyde (4% wt/wt), optionally saponin (0.05% wt/wt), and phosphate buffered saline (PBS 1x), and water to in quantity sufficient to arrive at the indicated concentrations.

The term “clarification fluid” is intended to mean an electrophoresis solution, such as a buffer solution, such as the clearing solution described in US Patent Application No. US2015/2015/0144490, which is incorporated herein by reference in its entirety. For example, the solution may contain water, boric acid (200 mM), a detergent such as SDS (e.g. 4% wt/wt), and adjusted to pH 8.5 with NaOH. Other clarification fluids are also suitable.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 illustrates an electrophoretic tissue clearing chamber according to an embodiment of the present invention;

FIG. 2 illustrates side and top views of an electrophoretic tissue clearing chamber according to an embodiment of the present invention;

FIG. 3 illustrates two portions of an electrophoretic tissue clearing chamber according to an embodiment of the present invention.

FIG. 4 illustrates two portions of an electrophoretic tissue clearing chamber according to an embodiment of the present invention.

FIG. 5 illustrates a second portion of an electrophoretic tissue clearing chamber according to an embodiment of the present invention.

FIG. 6 illustrates a first portion of an electrophoretic tissue clearing chamber according to an embodiment of the present invention.

FIG. 7 illustrates a tissue sample holder of an electrophoretic tissue clearing chamber according to an embodiment of the present invention.

FIG. 8 illustrates a tissue sample before and after treatment with the CLARITY protocol in an electrophoretic tissue clearing chamber according to an embodiment of the present invention.

FIG. 9 illustrates a tissue sample imaged with a two photon microscope after the CLARITY protocol in an electrophoretic tissue clearing chamber according to an embodiment of the present invention.

FIG. 10A illustrates top view of a first portion of an electrophoretic tissue clearing chamber according to an embodiment of the present invention.

FIG. 10B illustrates a section B-B of a first portion of an electrophoretic tissue clearing chamber according to an embodiment of the present invention.

FIG. 10C illustrates a section A-A of a first portion of an electrophoretic tissue clearing chamber according to an embodiment of the present invention.

FIG. 10D illustrates a perspective first portion of an electrophoretic tissue clearing chamber according to an embodiment of the present invention.

FIG. 11A illustrates a section A-A of a second portion of an electrophoretic tissue clearing chamber according to an embodiment of the present invention.

FIG. 11B illustrates a section B-B of a second portion of an electrophoretic tissue clearing chamber according to an embodiment of the present invention.

FIG. 11C illustrates a top view of a second portion of an electrophoretic tissue clearing chamber according to an embodiment of the present invention.

FIG. 11D illustrates a perspective view of a second portion of an electrophoretic tissue clearing chamber according to an embodiment of the present invention.

It will be noted that throughout the appended drawings, like features are identified by like reference numerals.

### DETAILED DESCRIPTION

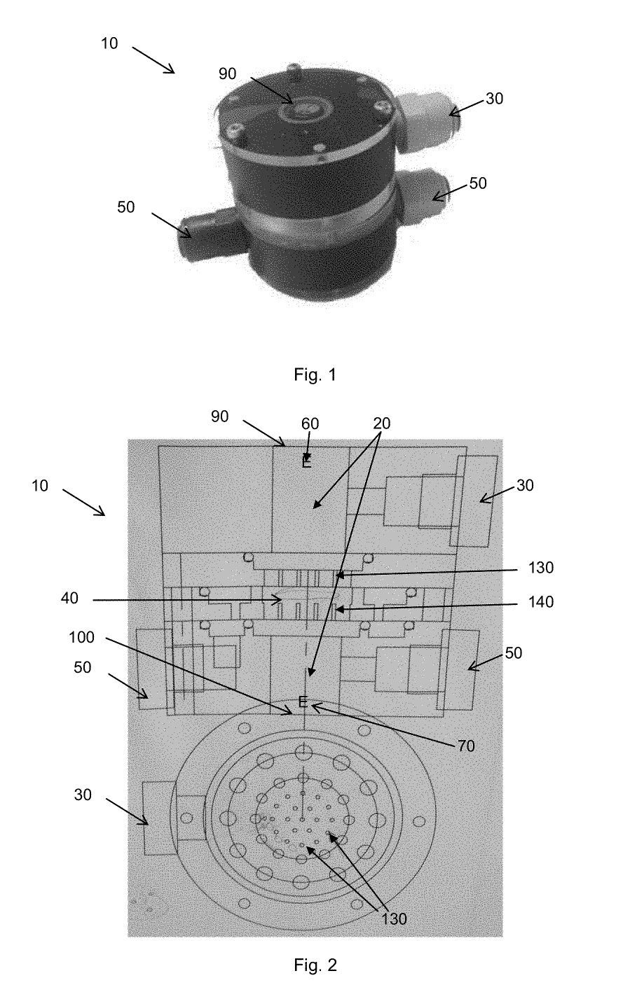

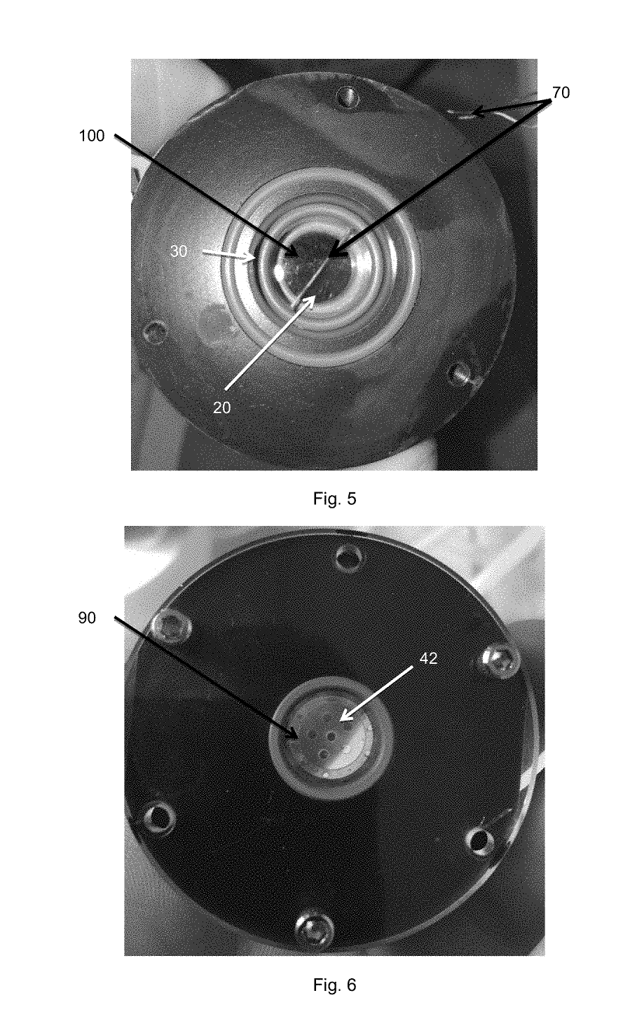

Now referring to FIGS. 1 to 5, 10A-D and 11A-D, in embodiments there is disclosed an electrophoretic tissue clearing chamber 10 which comprises an electrophoresis channel 20, configured to receive a clarification fluid therethrough, a first clarification fluid inlet 30, in fluid communication with the electrophoresis channel, configured to be connected to a source of the clarification fluid, a tissue sample holder 40 in fluid communication with the electrophoresis channel 20, configured to receive a tissue sample to be clarified, and pressurize and homogenously apply the clarification fluid onto the tissue sample; a clarification fluid outlet 50, in fluid communication with the tissue sample holder, for exit of the clarification fluid from the electrophoretic tissue clearing chamber, and a first and a second electrode 60 and 70 respectively, opposite one another in the electrophoresis channel 20, for transmission of an electric field therethrough.

In embodiments as shown in the FIGS. 1-5, 10A-D and 11A-D the electrophoresis channel 20 effectively traverses the electrophoresis chamber 10, and is in fluid communication with a number of elements therein. The electrophoresis channel 20 is configured to receive a clarification fluid therethrough, which will contact the samples to be clarified.

In embodiments, in fluid communication with the electrophoresis channel 20 is a first clarification fluid inlet 30, through which enters the clarification fluid. According to another embodiment, the electrophoresis tissue clearing chamber 10 may further comprise a second clarification fluid inlet, in fluid communication with the electrophoresis channel 20. The second clarification fluid inlet is also configured to be connected to a source of clarification fluid, and provides an opposing flow of clarification fluid to the flow of clarification fluid from the first clarification fluid inlet 30. Without wishing to be bound by theory, it is believed that this opposing flow generates a turbulent flow of clarification fluid against the tissue samples, and improves clarification of the tissue samples therein.

According to another embodiment, the electrophoresis chamber 10 may further comprise first and second viewing windows 90 and 100 respectively, opposite one another in the electrophoresis channel, for visualization of the tissue samples therein, to assess the degree of completion of the clarification.

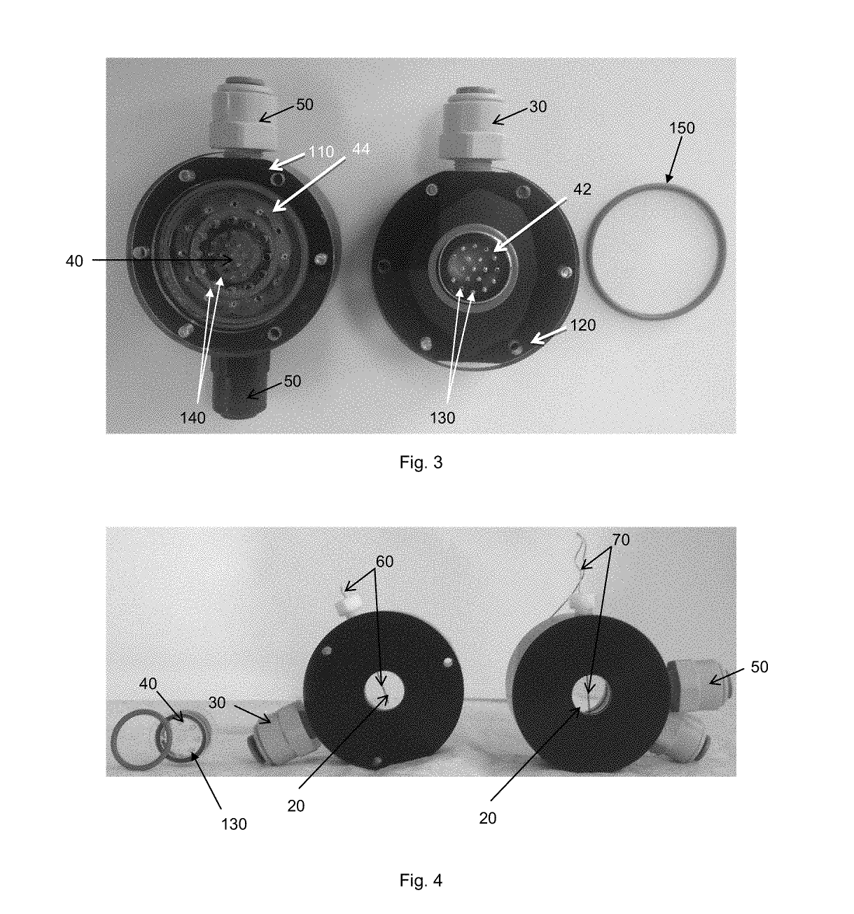

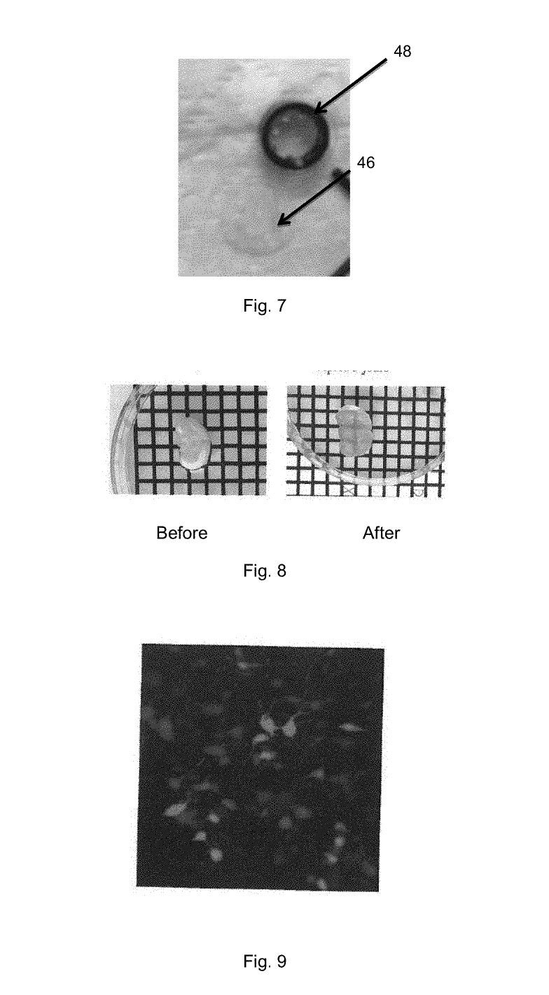

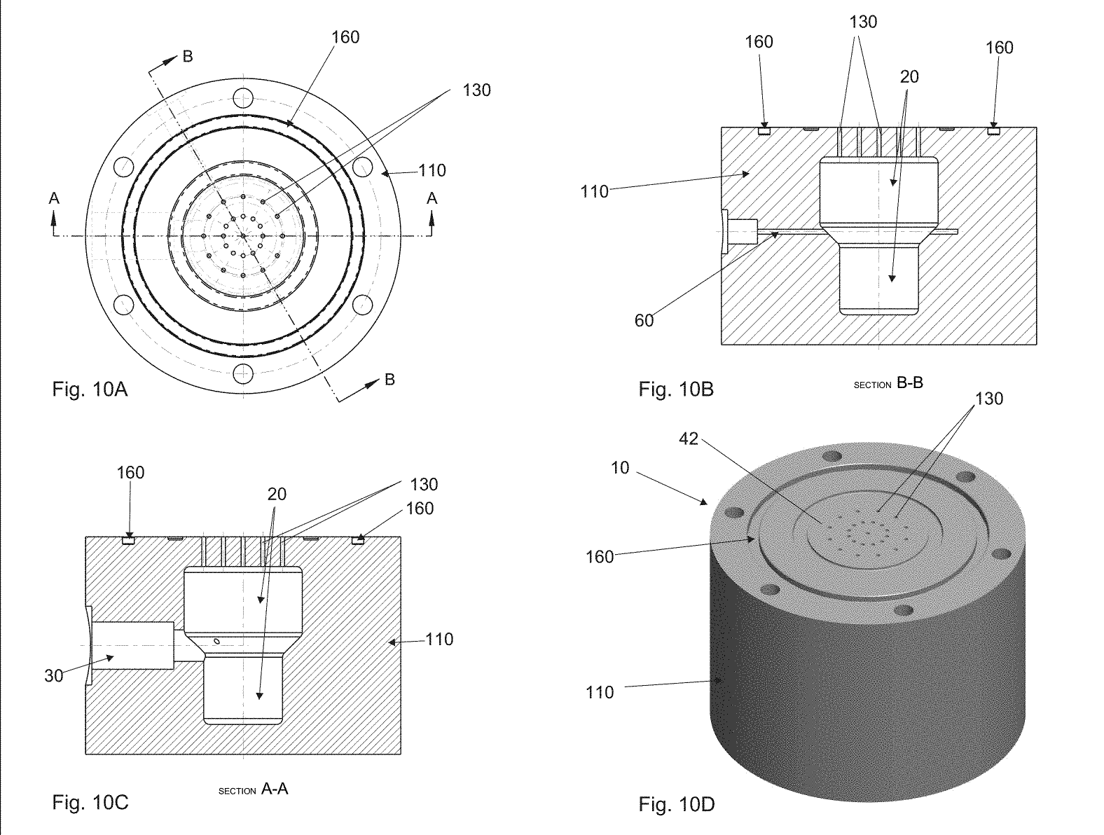

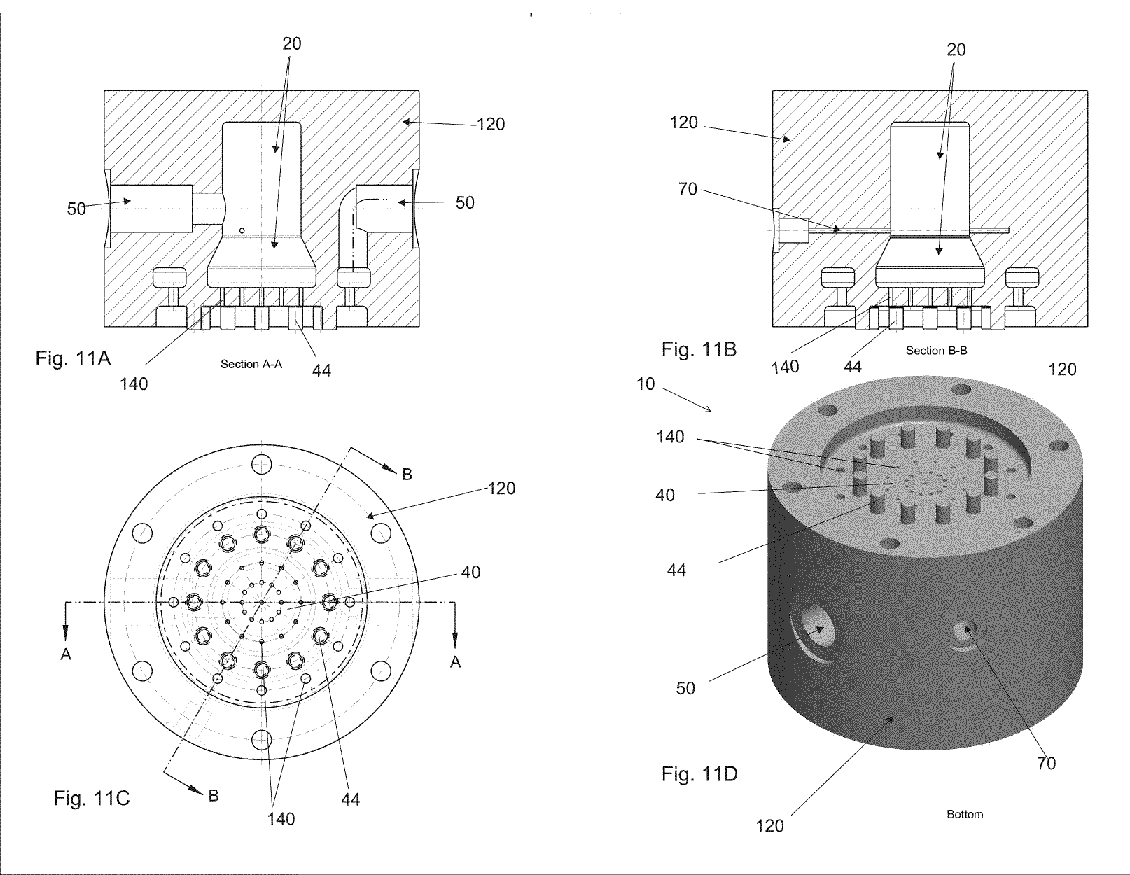

According to an embodiment, electrophoresis chamber 10 comprises a tissue sample holder 40, which is in fluid communication with the electrophoresis channel 20 and is configured to receive the tissue sample to be clarified and pressurize and homogenously apply the clarification fluid onto the tissue sample. According to an embodiment, the tissue sample holder 40 may be integral to the electrophoresis channel 20, directly in the flow of clarification fluid flowing through the electrophoresis channel 20 (See, e.g. FIGS. 10 and 11). According to another embodiment, the tissue sample holder 40 may be inserted into the electrophoresis channel 20, directly in the flow of clarification fluid flowing through the electrophoresis channel 20. For example, according to an embodiment, the tissue sample holder 40 may be comprised of a tissue sample holder first portion 42 (See FIG. 3, and FIG. 6 as seen through first viewing window 90) and a tissue sample holder second portion 44 which reversibly join to form the tissue sample holder 40, thereby sealably joining a first and second portion (110, 120) to form the electrophoresis tissue clearing chamber. In another embodiment, now referring to FIG. 7, the tissue sample holder 40 may comprise a tissue sample holder first portion 46, comprising means to pressurize and homogenously apply the clarification fluid onto the tissue sample; and a tissue sample holder second portion 48, configured to receive a tissue sample to be clarified, comprising means for exit of the clarification fluid; where the tissue sample holder first portion 46 and the tissue sample holder second portion 48 are configured to reversibly join to form the tissue sample holder 40, which may be inserted into the electrophoresis channel 20. For example, in a “two portion” electrophoresis tissue clearing chamber 10 as shown in the Figs., the tissue sample holder 40 may be inserted in the second portion and the first and second portion of the electrophoresis tissue clearing chamber 10 sealably and reversibly join to form the electrophoresis tissue clearing chamber 10.

The tissue sample holder 40 is configured to pressurize and homogenously apply the clarification fluid onto the tissue sample. While many means may be used to achieve this, according to an embodiment, the tissue sample holder 40 may comprise a plurality of fluid entry aperture 130 (FIGS. 2-3 and 10A-D), homogenously distributed on the face of the tissue sample holder 40, for homogeneous and pressurized application of the clarification fluid onto tissue samples.

The clarification fluid flowing through the electrophoresis channel 20 from the clarification fluid inlet 30 arrives at the tissue sample holder 40 and has to enter the tissue holder through the plurality of fluid entry apertures 130, thereby increasing the pressure of the fluid entering the central cavity of the tissue sample holder 40 where the samples are residing during treatment. According to particular embodiments, the diameter of the fluid entry apertures 130 may be 1 mm or less, or from about 0.5 mm to about 1 mm, or from about 0.8 mm to about 0.9 mm. In embodiments, the number of fluid entry apertures 130 may be from about 13 apertures/cm² to about 17 apertures/cm², or about 15 apertures/cm².

In embodiments, tissue sample holder 40 also comprises a plurality of fluid exit aperture 140 (FIGS. 2-3 and 11A-D), for exit of the clarification fluid from the tissue sample holder 40 after having been in contact with the tissue samples therein. The fluid exit apertures 140 are dimensioned and positioned on the exit side of the tissue sample holder 40 so as to maintain a level of fluid sufficient to keep the tissue samples therein in contact with clarification fluid and prevent drying. According to particular embodiments, the diameter of the fluid exit apertures 140 may be 1 mm or less, or from about 0.5 mm to about 1 mm, or from about 0.8 mm to about 0.9 mm. In embodiments, the number of fluid exit apertures 140 may be from about 10 apertures/cm² to about 14 apertures/cm², or about 11.5 apertures/cm². According to another embodiment, the tissue holder 40 comprises a porous surface through which the clarification fluid having been in contact with the tissue samples therein may exit.

Following exit of the clarification fluid from the tissue sample holder fluid exit aperture, the clarification fluid flows through the electrophoresis channel 20 and exits the chamber 10 through the clarification fluid outlet 50, in fluid communication with the tissue sample holder. According to an embodiment, the tissue clearing chamber of the present invention may have more than one clarification fluid outlet 50 (e.g. FIG. 11A).

In embodiments, the tissue clearing chamber 10 also comprises a first and a second electrode 60 and 70 respectively, which are located opposite one another in the electrophoresis channel 20, for transmission of an electric field therethrough, which is necessary to effect the electrophoresis on the tissue samples in the tissue sample holder 40. The electrode 60 and 70 may be any suitable electrode of any shape, form or material. Preferably, the electrodes are platinum electrodes. A suitable power supply may be connected to the electrodes 60 and 70 to provide the required electric current to effect electrophoresis. FIGS. 10B and 11B and D show the opening where the electrodes 60 and 70, respectively, are inserted.

According to an embodiment of the present invention, the electrophoresis tissue clearing chamber 10 may comprise a first portion 110 comprising the first clarification fluid inlet 30, in fluid communication with the electrophoresis channel 20, configured to be connected to a source of the clarification fluid, a tissue sample holder first portion 42, comprising means 130 to pressurize and homogenously apply the clarification fluid onto the tissue sample, and a first electrode 60. The electrophoresis tissue clearing chamber 10 also comprises a second portion 120 comprising a tissue sample holder second portion 44, configured to receive a tissue sample to be clarified, comprising means for exit of the clarification fluid from the tissue sample holder 40 (i.e. exit apertures 140 or a porous surface through which the clarification fluid having been in contact with the tissue samples therein may exit), the clarification fluid outlet 50, in fluid communication with the tissue sample holder second portion 44, for exit of the clarification fluid from the electrophoretic tissue clearing chamber; and the second electrode 70. The tissue sample holder first portion 42 and the tissue sample holder second portion 44 reversibly join to form the tissue sample holder 40, thereby sealably joining the first and second portion (110, 120) to form the electrophoresis tissue clearing chamber.

According to an embodiment of the present invention, the electrophoresis tissue clearing chamber 10 may comprise a first portion 110 comprising the first clarification fluid inlet 30, in fluid communication with the electrophoresis channel 20, configured to be connected to a source of the clarification fluid and the first electrode 60. The electrophoresis tissue clearing chamber 10 also comprises a second portion 120 comprising the clarification fluid outlet 50, in fluid communication with the tissue sample holder second portion 44, for exit of the clarification fluid from the electrophoretic tissue clearing chamber 10, and the second electrode 70. In this embodiment, the tissue sample holder 40 comprises a tissue sample holder first portion 42, comprising means to pressurize and homogenously apply the clarification fluid onto the tissue sample; and a tissue sample holder second portion 44, configured to receive a tissue sample to be clarified, comprising means for exit of the clarification fluid (i.e. exit apertures 140 or a porous surface through which the clarification fluid having been in contact with the tissue samples therein may exit), where the tissue sample holder first portion 42 and the tissue sample holder second portion 44 are configured to reversibly join to form the tissue sample holder 40, and the tissue sample holder 40 inserts into the second portion 120, and the first and second portions (110, 120) sealably and reversibly join to form the electrophoresis tissue clearing chamber 10. A suitable seal, such as a rubber seal 150 (FIG. 3) may be used to form a tight seal between the two portions of the tissue clearing chamber 10. According to an embodiment, the suitable seal 150 may be inserted, for example, in a seal receiving groove 160 (FIG. 10A-D).

According to another embodiment there is disclosed a method of clarifying a tissue sample comprising the step of treating the tissue sample in an electrophoretic tissue clearing chamber 10 of the present invention having a clarification fluid and a suitable electric current flowing therethrough, for a time sufficient and at a flow rate sufficient to clarify the tissue.

The present invention will be more readily understood by referring to the following examples which are given to illustrate the invention rather than to limit its scope.

### Example 1

### Test of Electrophoretic Clearing Chambers

The electrophoretic tissue clearing chambers of the present invention were tested to compare their performance with the original tissue clearing chamber employed with the CLARITY technique. The results are presented in Table 1 below.

TABLE 1
comparison of electrophoretic tissue clearing chambers

| | | | | | Interval for | |
|---|---|---|---|---|---|---|
| | Brain | | | | replacement | |
| | sample | Duration of | Electric | Constant | of CLARITY | |
| | size | procedure | current | Voltage | solution | |
| ETC | (mm) | (days) | (mA) | (V) | (days) | Transparency |
| Original | Complete | 8 | 350 | 25 | N/A | Very obscure |
| | brain | | | | | − |
| None - | Slice - | 28 | N/A | N/A | Every two | Good |
| Passive | 600 μm | | | | days | ++ |
| diffusion | | | | | | |
| Present | Slice - | 2 | 16 | 20 | N/A | Good |
| invention - | 600 μm | | | | | ++ |
| FIG. 1 | | | | | | |
| Present | Slice - | 5 | 50 | 27 | N/A | Excellent |
| invention - | 2.5 mm | | | | | +++ |
| FIG. 4 | | | | | | |

The electrophoretic tissue clearing chambers were capable of decreasing the duration of the procedure as well as dramatically improve the quality (i.e. transparency) of the tissue sample treated therein. FIG. 8 illustrates the slice of brain before and after the 5 day treatment in the chamber of the present invention. The transparency of the treated sample is excellent and easily visible with the naked eye.

Following clarification with following the regular CLARITY protocol in the chamber of the present invention, tissue samples from Tyrosine Hydrolase-GFP transgenic animals were visualized with a 2 photon microscope (Olympus V1000) and an image reconstruction software, at a depth of 300 μm. The results are shown in FIG. 9; confirm that the technique and the chambers work well.

While preferred embodiments have been described above and illustrated in the accompanying drawings, it will be evident to those skilled in the art that modifications may be made without departing from this disclosure. Such modifications are considered as possible variants comprised in the scope of the disclosure.

1. An electrophoretic tissue clearing chamber comprising:
an electrophoresis channel, configured to receive a clarification fluid therethrough;
a first clarification fluid inlet, in fluid communication with said electrophoresis channel, configured to be connected to a source of said clarification fluid;
a tissue sample holder in fluid communication with said electrophoresis channel, configured to receive a tissue sample to be clarified, and pressurize and homogenously apply said clarification fluid onto said tissue sample;
a clarification fluid outlet, in fluid communication with said tissue sample holder, for exit of said clarification fluid from said electrophoretic tissue clearing chamber; and
a first and a second electrode, opposite one another in said electrophoresis channel, for transmission of an electric field therethrough.

2. The electrophoresis tissue clearing chamber of claim 1, further comprising a second clarification fluid inlet, in fluid communication with said electrophoresis channel, configured to be connected to a source of said clarification fluid, and provide an opposing flow of clarification fluid to a flow of clarification fluid from said first clarification fluid inlet, to generate turbulent flow against said tissue samples.

3. The electrophoresis tissue clearing chamber of claim 1, further comprising first and second viewing windows, opposite one another in said electrophoresis channel, for visualization of said tissue samples therein.

4. The electrophoresis tissue clearing chamber of claim 1, wherein said tissue sample holder comprises a plurality of fluid entry aperture for homogeneous and pressurized application of said clarification fluid onto said tissue samples.

5. The electrophoresis tissue clearing chamber of claim 1, wherein said tissue sample holder comprises a plurality of fluid exit aperture for exit of said fluid from said tissue sample holder.

6. The electrophoresis tissue clearing chamber of claim 1, wherein said tissue sample holder comprises a porous surface, for exit of the clarification fluid from the tissue sample holder after contacting said tissue sample.

7. The electrophoresis tissue clearing chamber of claim 1, further comprising a second clarification fluid inlet, for providing an opposing flow of clarification fluid to a flow of clarification fluid from said first clarification fluid inlet.

8. The electrophoresis tissue clearing chamber of claim 1, wherein said tissue holder is integral to said electrophoresis channel.

9. The electrophoresis tissue clearing chamber of claim 1, wherein said tissue holder is separate and inserted into said electrophoresis channel.

10. The electrophoresis tissue clearing chamber of claim 9, wherein said tissue holder comprises a tissue holder first portion sealably joined to a tissue holder second portion.

11. The electrophoresis tissue clearing chamber of claim 1, wherein said electrophoresis tissue clearing chamber comprises
a first portion comprising
said first clarification fluid inlet, in fluid communication with said electrophoresis channel, configured to be connected to a source of said clarification fluid;
a tissue sample holder first portion, comprising means to pressurize and homogenously apply said clarification fluid onto said tissue sample; and
said first electrode,
and
a second portion comprising
a tissue sample holder second portion, configured to receive a tissue sample to be clarified, comprising means for exit of said clarification fluid;
said clarification fluid outlet, in fluid communication with said tissue sample holder second portion, for exit of said clarification fluid from said electrophoretic tissue clearing chamber; and
said second electrode,
wherein said tissue sample holder first portion and said tissue sample holder second portion reversibly join to form said tissue sample holder, thereby sealably joining said first and second portion to form said electrophoresis tissue clearing chamber.

12. The electrophoresis tissue clearing chamber of claim 1, wherein said electrophoresis tissue clearing chamber comprises
a first portion comprising
said first clarification fluid inlet, in fluid communication with said electrophoresis channel, configured to be connected to a source of said clarification fluid;
said first electrode,
a second portion comprising
said clarification fluid outlet, in fluid communication with said tissue sample holder second portion, for exit of said clarification fluid from said electrophoretic tissue clearing chamber; and
said second electrode,
wherein said tissue sample holder comprises
a tissue sample holder first portion, comprising means to pressurize and homogenously apply said clarification fluid onto said tissue sample; and
a tissue sample holder second portion, configured to receive a tissue sample to be clarified, comprising means for exit of said clarification fluid;
wherein said tissue sample holder first portion and said tissue sample holder second portion are configured to reversibly join to form said tissue sample holder, and
wherein said tissue sample holder inserts into said second portion, and
wherein said first and second portion sealably and reversibly join to form said electrophoresis tissue clearing chamber.

13. The electrophoresis tissue clearing chamber of claim 11, wherein means to pressurize and homogenously apply said clarification fluid onto said tissue sample comprises a plurality of fluid entry apertures, for homogeneous and pressurized application of said clarification fluid onto said tissue sample.

14. The electrophoresis tissue clearing chamber of claim 12, wherein means to pressurize and homogenously apply said clarification fluid onto said tissue sample comprises a plurality of fluid entry apertures, for homogeneous and pressurized application of said clarification fluid onto said tissue sample.

15. The electrophoresis tissue clearing chamber of claim 11, wherein means for exit of said clarification fluid comprises a plurality of fluid exit apertures, a porous surface, or a combination thereof, for exit of the clarification fluid from the tissue sample holder after contacting said tissue sample.

16. The electrophoresis tissue clearing chamber of claim 12, wherein means for exit of said clarification fluid comprises a plurality of fluid exit apertures, a porous surface, or a combination thereof, for exit of the clarification fluid from the tissue sample holder after contacting said tissue sample.

17. A method for clarifying a tissue sample comprising the step of:
a) treating the tissue sample in an electrophoretic tissue clearing chamber according to claim 1, having a clarification fluid and a suitable electric current flowing therethrough, for a time sufficient, at a flow rate sufficient to clarify said tissue.

18. The method of claim 15, wherein said tissue sample is a fixed tissue sample.
